(19) United States
(12) Patent Application Publication
(10) Pub. No.: US 2012/0307051 A1
(43) Pub. Date: Dec. 6, 2012

(54) VIDEO ENABLED ELECTRONIC ARTICLE SURVEILLANCE DETECTION SYSTEM AND METHOD

(75) Inventor: John Joseph WELTER, Delray Beach, FL (US)

(73) Assignee: SENSORMATIC ELECTRONICS, LLC, Boca Raton, FL (US)

(21) Appl. No.: 13/150,985

(22) Filed: Jun. 1, 2011

(51) Int. Cl. G08B 13/22; H04N 7/18

(52) U.S. Cl. 348/143; 340/572.1; 348/E07.085

(57) ABSTRACT

A security system and method is provided that uses an auxiliary sensor, such as a video camera, to verify the presence of an object within a part of an interrogation zone. The presence of an activated security system tag in an interrogation zone is detected. The system also determines whether an object is in a surveillance detection zone when the activated security system tag is detected. An alarm is initiated if the object is in the surveillance detection zone within a predetermined time after the activated security system tag is detected in the interrogation zone. The alarm may be based on the direction of motion of the object in the surveillance zone.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates generally to a method and system for electronic article surveillance (“EAS”) and more specifically to an EAS method and system that includes video confirmation.

### BACKGROUND OF THE INVENTION

Electronic article surveillance (“EAS”) is a technological method for preventing shoplifting from retail stores or pilferage of books from libraries. Special tags are fixed to merchandise or books. These tags are removed or deactivated by the clerks when the item is properly bought or checked out. At the exits of the store or library, a detection system sounds an alarm or flashes lights to otherwise alert the staff when active tags are sensed. Typically, a detection system is configured at an exit point of the protected area, which comprises one or more transmitters and antennas (“pedestals”) capable of generating an electromagnetic field across the exit, known as the “interrogation zone.” Articles to be protected from removal are tagged with an EAS marker that, when active, generates an electromagnetic response signal when passed through this interrogation zone. An antenna and receiver in the same or another “pedestal” detects this response signal and generates an alarm.

Ideally, the interrogation zone is confined to an area immediately proximate to an exit. However, as a practical matter, the interrogation zone of an EAS detection system may cover an area so large that it activates when a person with an item with an activated EAS tag is in the vicinity of a store exit, but not actually exiting the store. The region covered by the EAS detection system that is outside the immediate exit area is sometimes referred to as the over-range region. Thus, if the gain of the EAS receiver and/or transmitter is high, an alarm may sound when a shopper or an item is near the exit, but not actually exiting the store. However, if the gain is too low, an item with an activated EAS tag may exit the store undetected. Undesirable time and expense is involved in making the detection area small enough that only articles very near the exit cause an alarm.

Therefore, what is needed is a system and method of determining when a shopper with an item with an activated EAS tag is actually entering or exiting a monitored area.

### SUMMARY OF THE INVENTION

The present invention provides a method and system to detect when an item with an activated tag, such as an EAS tag or an RFID tag, is within a surveillance detection zone. According to one aspect, the invention provides a method of preventing an inadvertent alarm caused by presence of an item with an activated tag in proximity to, but outside of, of a surveillance detection zone. The presence of an activated security system tag in an interrogation zone is detected. A determination is made as to whether an object is in a surveillance detection zone when the activated security system tag is detected. An alarm or alert signal is initiated if the object is in the surveillance detection zone within a predetermined time after the activated security system tag is detected in the interrogation zone.

According to another aspect, the invention provides an electronic article surveillance (EAS) detection system. An EAS detector detects a signal indicative of a presence of an activated EAS tag within an interrogation zone. A video camera capturing images of objects within a surveillance zone. A controller is in communication with the EAS detector and the video camera. The controller activates an alarm when an object is in the surveillance detection zone within a predetermined time of energy indicative of the presence of the activated EAS tag being detected.

According to yet another aspect, the invention provides an article detection system. A detector detecting an activated tag in an interrogation zone formed by the detector. A sensor detects the presence of an object within a video surveillance detection zone formed by the sensor. A controller is in communication with the first detector and the sensor. The controller determines whether the object is present within the video surveillance detection zone when the activated tag is also in the interrogation zone.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of an exemplary video-enabled EAS system constructed in accordance with the principles of the present invention;

FIG. 2 is a block diagram of an exemplary EAS system controller constructed in accordance with the principles of the present invention;

FIG. 3 is a diagram of an exemplary EAS interrogation zone that encompasses all or part of a surveillance detection zone; and

FIG. 4 is a flow chart of an exemplary process for detecting whether an item with an activated EAS tag is within a surveillance detection zone.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for determining when an item with an activated EAS tag is entering or leaving an area. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

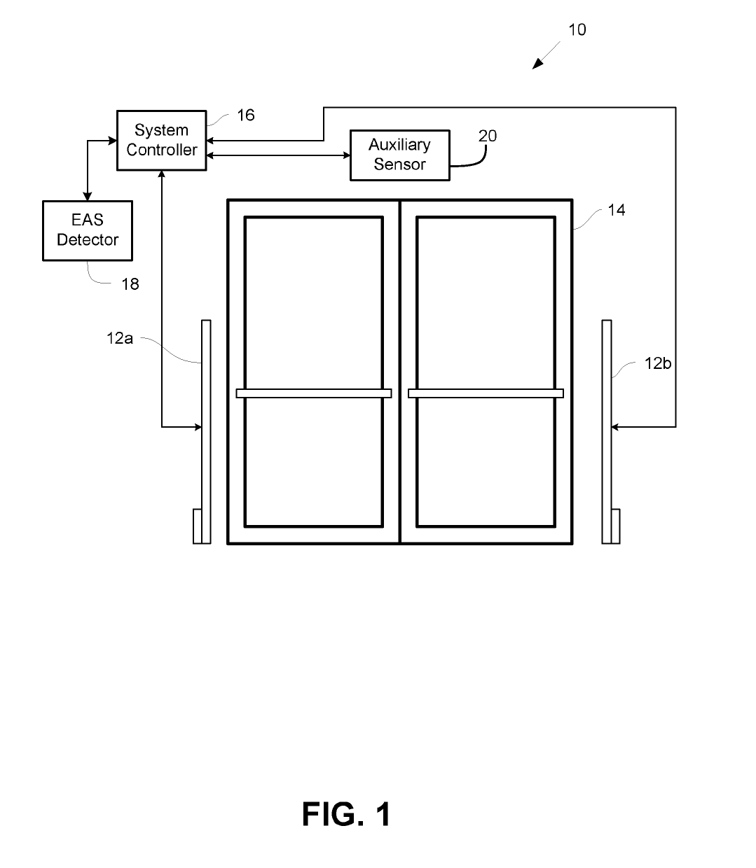

One embodiment of the present invention advantageously provides a method and system for detecting when an item with an activated EAS tag is actually entering or exiting a monitored area. Referring now to the drawing figures in which like reference designators refer to like elements, there is shown in FIG. 1 a configuration of an exemplary EAS detection system 10 constructed in accordance with the principles of the present invention and located, for example, at a facility exit/entrance. The EAS detection system 10 includes a pair of pedestals 12a, 12b (collectively referenced as pedestal 12) on opposite sides of an exit 14. One or more antennas for the EAS detection system 10 may be included in pedestals 12a and 12b, which are located a known distance apart. The antennas located in the pedestals 12 are electrically coupled to a control system 16, which controls the operation of the EAS detection system 10. Note that instead of, or in addition to, the EAS detection system 10, an radio frequency identification (“RFID”) system may be implemented to detect the presence of an item with an activated RFID tag in an RFID interrogation zone.

The system controller 16 is electrically connected to an EAS detector 18, and an auxiliary sensor 20 to detect the presence of an object in a surveillance zone of detection. The term “object” as used herein refers to a thing in the general sense and t may include a person, item and other tangible objects of interest that may be identified. The antennas of the EAS detection system may define an interrogation zone wherein the EAS detector 18 can detect an item with an activated EAS tag. A surveillance detection zone defined by the detection zone of the auxiliary sensor 20 may be encompassed, at least in part, by the interrogation zone. The surveillance zone may be arranged to exclude the over-range region of the interrogation zone. The EAS detector 18 may be a separate unit, communicatively connected to the system controller 16, or may be integrated into the system controller 16.

The auxiliary sensor 20 may be a video camera or RFID detector that may be mounted above the facility entrance/exit and have a field of view that defines or substantially coincides with the surveillance detection zone to detect whether a person and/or an object is within the surveillance detection zone. For example, the auxiliary sensor 20 may be mounted approximately 8 to 14 feet (2.5 m to 4.3 m) above the facility entrance/exit. Note that although FIG. 1 shows a single auxiliary sensor 20, the invention is not limited to a single auxiliary sensor. It is contemplated that multiple auxiliary sensors may be used.

The auxiliary sensor 20 may communicate with the system controller 16 via a digital protocol, e.g. TCP/IP, or by an analog signal. The analog signals may be converted to digital signals via an analog to digital (A/D) converter in the system controller 16. The system controller 16 may perform image processing functions to identify a part of the image such as a person or an object, etc., to characterize the image. For example, an image processor of the system controller 16 may employ face detection, edge detection, gradient analysis, motion estimation, etc. In some embodiments, the auxiliary sensor 20 may include a central processing unit that executes an image processing algorithm to process an image captured by the sensor 20, e.g., sensor 20 performs image processing functions. Alternatively, the image processing may be performed by the system controller 16.

In some embodiments, an image processor of the system controller 16 may be responsive to an identification of an object based on its interrogated tag information. For example, an RFID element in the tag, when interrogated, may emit a signal that indicates the identity of the item. This information may be coupled to the image processor of the system controller that searches the image for the identified item. The algorithms used by the image processor may be based on the identity of the item. For example, one algorithm may be used to search for a large item and another algorithm (or the same algorithm with different parameters) may be used to search for a small item. As another example, the algorithm may be adapted to find an item of a particular color, as identified by interrogating the RFID tag element.

In some embodiments, the auxiliary sensor 20 may be configured to count people exiting or entering the exit doors 14. Integrating people counting sensors with the EAS detection pedestal 12 helps to ensure a simple and effective method of delivering essential operational information. In operation, the people counter detects the movement of a person into, through, or out of the predetermined area. That information is collected and processed by a people counting system, e.g., using a programmed microprocessor. The counting data may then be transmitted to other portions of the EAS detection system 10 using conventional networking components. The counting data may be transmitted through the store's internal network or across wide area networks such as the Internet, where it can be sorted, reported and studied. Or the counting data may be used in conjunction with the EAS detector to validate activated tags.

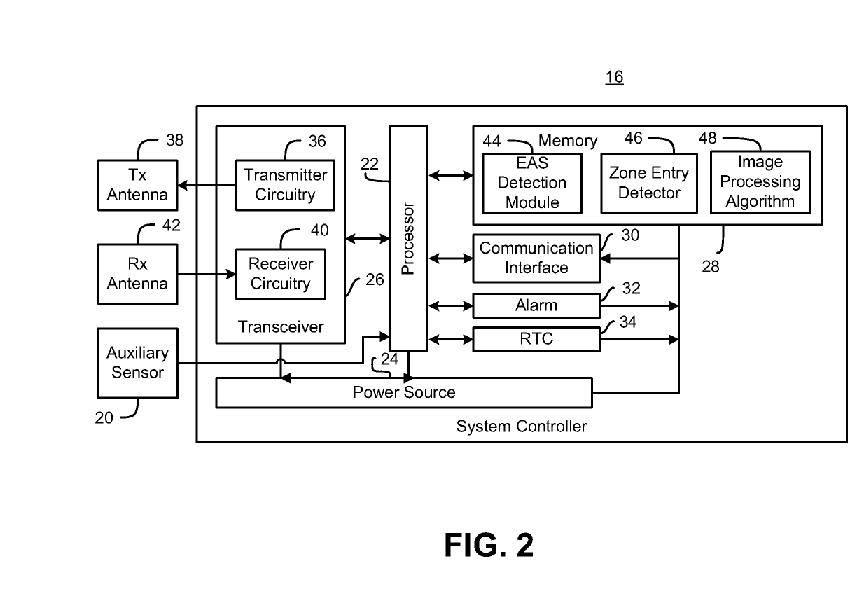

Referring now to FIG. 2, an exemplary EAS system controller 16 may include a processor 22 (e.g., a microprocessor), a power source 24, a transceiver 26, a memory 28 (which may include non-volatile memory, volatile memory, or a combination thereof), a communication interface 30 and an alarm 32. The processor 22 controls radio communications, storage of data to memory 28, communication of stored data to other devices, image processing, and activation of the alarm 32. The power source 24, such as a battery or AC power, supplies electricity to the EAS control system 16. The alarm 32 may include software and hardware for providing a visual and/or audible alert in response to detecting an item with an activated EAS tag in an interrogation zone of the EAS system 16.

The system 16 may also include a real time clock (RTC) 34 for timing purposes, such as, to time duration of the presence of an item in the surveillance detection zone. In one embodiment, upon detection of an item with an activated EAS tag in the interrogation zone of the EAS or RFID system, followed by detection of a person or object in the surveillance detection zone, the RTC 34 may compute the time during which the person remains in the surveillance detection zone. The computed time may be compared to a threshold which, if exceeded, causes the system 16 to activate an alarm. The RTC 34 may also measure a time interval between detecting an activated tag and triggering the auxiliary sensor, to account for a time it takes for a person first entering the EAS interrogation zone to reach the surveillance detection zone.

The transceiver 26 may include a transmitter 36 electrically coupled to one or more transmitting antennas 38 and a receiver 40 electrically coupled to one or more receiving antennas 42. Alternately, a single antenna or pair of antennas may be used as both the transmitting antenna 38 and the receiving antenna 42. In an exemplary system, the receive and transmit antennas may be positioned in the pedestals 12. For example, one of the pedestals could include a transmitting antenna 38 and a receiving antenna 42, whereas the other pedestal could include a reflective material. The receiver 38 detects the response signal of the EAS tag using the receive antenna 42.

The transmitter 26 transmits a radio frequency signal using the transmit antenna 38 to “energize” an EAS tag on an item within an interrogation zone of the EAS system 16. When an item is purchased, the tag is deactivated or removed by a clerk. When an item is not purchased, the tag is not deactivated or removed by the clerk, so that when energized by a signal from the transmit antenna 38, the tag emits a signal at a desired frequency that is detected by the receive antenna 42.

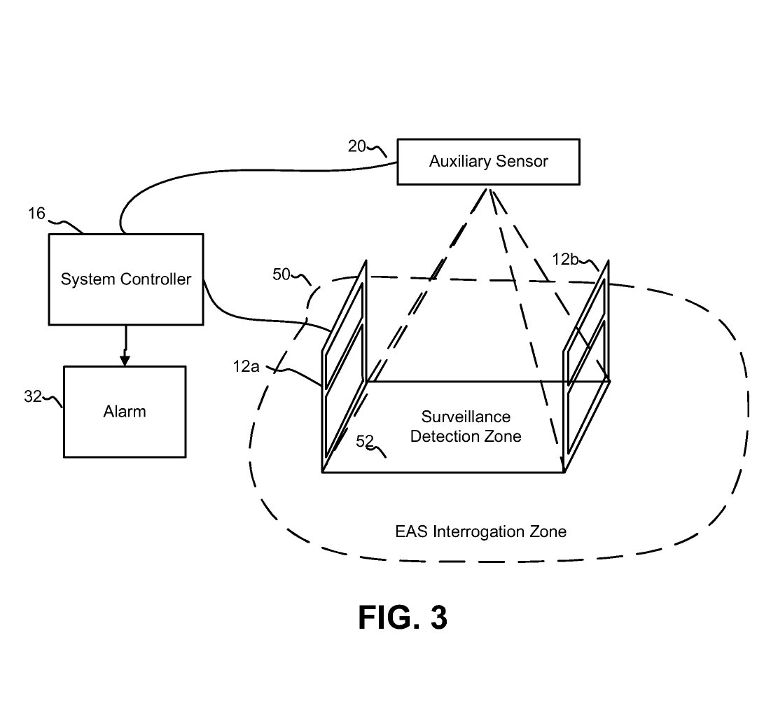

As is explained with reference to FIG. 3, the EAS interrogation zone may actually be larger than a surveillance detection zone monitored by the auxiliary sensor 20. Thus, it is possible that a person with an item with an activated EAS tag may be in the EAS interrogation zone and outside the surveillance detection zone. In this case, an alarm is not activated. However, when the person with the item with an activated EAS tag enters the surveillance detection zone, the alarm may be activated. The alarm may be activated immediately upon entry of the item with the activated tag to the surveillance detection zone or when the item remains in the surveillance detection zone for a pre-determined time entry into the surveillance detection zone. The alarm may include an audio alarm, visual alarm, alert signal generated by the system controller 16, among other alarms.

Thus, the memory 28 may include an EAS detection module 44 that includes software that, when executed by the processor 22, detects the presence of an item with an activated EAS tag within the EAS interrogation zone. The memory 28 may also include a zone entry detector 46 that includes software that, when executed by the processor 22, detects the presence of a person in a surveillance detection zone. The surveillance detection zone may be about the same size as, or smaller than, the EAS interrogation zone. In other words, the interrogation zone may overlap the surveillance detection zone in whole or in part, and may actually be larger than the surveillance detection zone.

The memory 28 may further comprise an image processing algorithm 48 which performs operations on the image captured by the auxiliary detector 20 to process the image. For example, an image processing algorithm 48 of the system controller 16 may employ face detection, edge detection, gradient analysis, motion estimation, etc. In some embodiments, the image processing algorithm 48 of the system controller 16 may be responsive to an identification of an object based on its interrogated tag information. For example, the EAS tag of an item, when interrogated, may emit a signal that indicates the identity of the item. This information may be coupled to the processor 22 of the system controller 16 that searches the image for the identified item. The image processing algorithm 48 used by the processor 22 may be based on physical characteristics of the item. For example, one algorithm may be used to search for a large item and another algorithm, (or the same algorithm with different parameters), may be used to search for a small item. As another example, the algorithm may be adapted to find an item of a particular color, as identified by interrogating the EAS or RFID tag of the item.

Thus, the memory 28 may include a database of information concerning product size, shape, and color associated with product identification data as detected from the tag. In some embodiments, the image processing algorithm 48 may function to differentiate between an object and a person, and may further be operable to digitally zoom in on a detected object. In another embodiment, the image processing algorithm 48 detects a direction of motion of the object, and can therefore detect whether the object is moving toward or away from an exit door. Implementing some form of image recognition within the surveillance detection zone allows what would otherwise be an alarm event to be inhibited. For example, by using image recognition to confirm the presence of a person or particular class of object in the surveillance detection zone, a situation where an object unintentionally passing through the surveillance detection zone, e.g., a rolling ball, combined with the detection of an active tag in the interrogation zone (even if in the over-range region) would not trigger an alarm.

FIG. 3 is a diagram of an exemplary EAS tag detection system constructed in accordance with the principles of the present invention. FIG. 3 shows a pair of parallel rails or pedestals 12a and 12b that partition a surveillance detection zone 50 from the remainder of a much larger area such as a store or library. Embedded in the pedestals 12, or positioned nearby, are antennas of an electronic article surveillance (EAS) system that has an interrogation zone 50 that covers an area that is typically larger than the surveillance detection zone 52. Thus, a person having an item with an activated EAS tag may be in the EAS interrogation zone 50, but outside the surveillance detection zone 52. In some embodiments, a radio frequency identification (RFID) system may be used instead of, or in addition to, the EAS system.

An auxiliary sensor 20 is configured to monitor the surveillance detection zone 52 to detect if an object is present within the surveillance detection zone 52. In one embodiment, the auxiliary sensor 20 may be a video system with a camera having a field of view that coincides with the surveillance detection zone 52. The video image detected by the camera may be monitored and/or recorded. For example, a video image of a person leaving or entering the facility may be recorded.

Further, the system controller 16 may perform image processing functions to identify a person or object in the image, and further identify a direction of motion of the object. In one embodiment, interrogation of the EAS or RFID tag may indicate a size or color of the tagged item, and the image processing algorithm executed by the system controller 16 may be adapted to locate an item of the specified size or color in the image.

The system controller 16 receives input from EAS detectors embedded in pedestals 12, and from the auxiliary sensor 20. The system controller 16 detects whether a person or object is in the surveillance detection zone 52 at the same time an item with an activated EAS tag is in the interrogation zone 50 in the vicinity of the surveillance detection zone 52. If a person or relevant object is in the surveillance detection zone at the same time an item with an activated EAS tag is in the interrogation zone, then an alarm 60 may be initiated or activated. However, if a person or relevant object is not in the surveillance detection zone when an item with an activated EAS tag is detected in the interrogation zone in the vicinity of the surveillance detection zone, then the alarm 60 is not activated. Similarly, if a person or object is in the surveillance detection zone but an item with an activated EAS tag is not detected in the interrogation zone in the vicinity of the surveillance detection zone, then the alarm 60 is not activated. In some embodiments, the alarm is not activated unless an object of a specific size or color is located in the surveillance detection zone, as determined by an image processing algorithm of the system controller 16.

Thus, in some embodiments, a detection apparatus is provided to detect when an item with an activated EAS tag is within a surveillance detection zone. The apparatus includes a first detector to detect the item with an activated EAS tag in proximity to the surveillance detection zone. A second detector detects the presence of a person or object within the surveillance detection zone. Logic circuitry determines whether the person or object is present within the surveillance detection zone at a time when the item with an activated EAS tag is in proximity to the surveillance detection zone.

In some embodiments, the detector that detects whether a person or object is in the surveillance detection zone may also actuate a counter to count persons passing through the detection zone. As noted above, some embodiments may have an RFID detection system instead of, or in addition to the EAS detection system. In some embodiments, the EAS detection system or RFID detection system actuates a product identifier that identifies a tagged item in the EAS or RFID interrogation zone. When a person carrying the product passes through the surveillance detection zone, as detected by an auxiliary detection system, an inventory count of the product may be reduced by one if exiting the store.

In some embodiments, the EAS or RFID system is capable of identifying the tagged object based on interrogation of the tag. For example, interrogation of the tag may indicate that the item is a certain product. When the item leaves the surveillance detection zone in the direction of the exit door, as determined by the system controller 16 based on analysis of the image captured by the sensor 20, the inventory count of the identified item may be reduced by one.

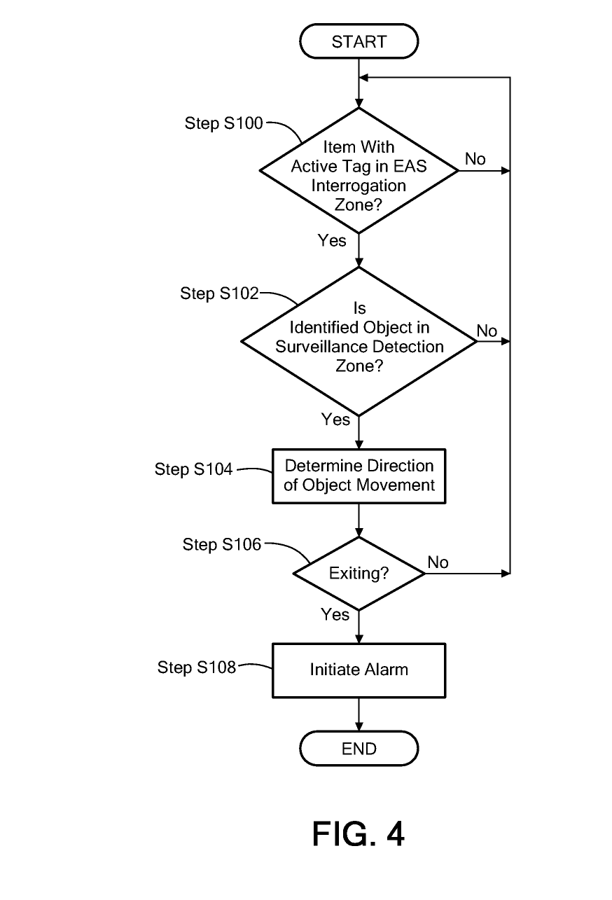

FIG. 4 is a flow chart of an exemplary process for detecting whether an object with an item with an activated EAS tag is within a detection zone. The system of the present invention detects whether an item with an activated EAS tag is in an interrogation zone 50 (step S100). The process of monitoring the interrogation zone continues until an activated EAS tag is detected. When an activated EAS tag is in the interrogation zone 50, then the system determines whether a person or relevant object is in the surveillance detection zone 52 (step S102). If not, then the process of monitoring the surveillance detection zone continues. If a person or relevant object is in the surveillance detection zone when an item with an activated EAS tag is in the interrogation zone, then the system determines the direction of movement of the person or relevant object (step S104). If the person or relevant object is exiting the store, the system may initiate an alarm (steps S106-S108). The alarm can be one or more of an audio alarm, a video alarm, or an alarm event signal sent to a monitoring station. Otherwise, the process of monitoring the surveillance detection zone continues, e.g., process moves from step S106 to step S100. In some embodiments, the system initiates a timer when an item with an activated EAS tag is first detected in an interrogation zone 50, i.e., at step S102. This allows time for a person with an item with an activated EAS tag to walk to the surveillance detection zone. When the timer reaches or exceeds the threshold the video is evaluated to determine whether a person or relevant object is in the surveillance detection zone. If so, then an alarm is activated.

In some embodiments, the auxiliary sensor may further determine whether a person is entering the surveillance detection zone from an entrance door or toward an exit door. When a person is entering the surveillance detection zone from an entrance door, no alarm is activated. When a person is entering the surveillance detection zone toward an exit door, and an item with an activated EAS tag is detected in the vicinity of the surveillance detection zone, then an alarm is activated. In another embodiment, an additional sensor may be provided to count the number of people passing through the surveillance detection zone. In other embodiments, the auxiliary sensor may perform the counting.

The present invention can be realized in hardware, software, or a combination of hardware and software. Any kind of computing system, or other apparatus adapted for carrying out the methods described herein, is suited to perform the functions described herein. A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method, comprising:
detecting the presence of an activated security system tag in an interrogation zone;
determining whether an object is in a surveillance detection zone when the activated security system tag is detected; and
initiating an alarm if the object is in the surveillance detection zone within a predetermined time after the activated security system tag is detected in the interrogation zone.

2. The method of claim 1, wherein whether an object is in the surveillance detection zone is determined using a video camera that captures an image of the object.

3. The method of claim 2, wherein the video camera is coupled to a recording device to record persons entering or leaving the surveillance detection zone.

4. The method of claim 2, further comprising analyzing the captured image.

5. The method of claim 4, wherein the image is analyzed to determine an identity of the item with the activated security system tag.

6. The method of claim 5, wherein the identity of the item with the activated security system tag is determined by searching a database of image data with data corresponding to the captured image.

7. The method of claim 4, wherein the image is analyzed to detect an object having at least one of a predetermined size and a predetermined color.

8. The method of claim 1, wherein the image is analyzed to determine when motion of the object is one of towards an exit and away from the exit of a facility.

9. An electronic article surveillance (EAS) detection system, comprising:
an EAS detector, the EAS detector detecting a signal indicative of a presence of an activated EAS tag within an interrogation zone;
a video camera, the video camera capturing images of objects within a surveillance zone;
a controller, the controller in communication with the EAS detector and the video camera, the controller activating an alarm when an object is in the surveillance detection zone within a predetermined time of energy indicative of the presence of the activated EAS tag being detected.

10. The electronic article surveillance detection system of claim 9, wherein the controller executes an image processing algorithm, wherein the controller determines whether an object is in the surveillance detection zone based on execution of the image processing algorithm.

11. The electronic article surveillance detection system of claim 10, wherein the image processing algorithm identifies an object in the surveillance detection zone as a person.

12. The electronic article surveillance detection system of claim 10, wherein the image processing algorithm identifies an object in the surveillance detection zone based on a physical characteristic of the object.

13. An article detection system, comprising:
a detector, the detector detecting an activated tag in an interrogation zone formed by the first detector;
a sensor, the sensor detecting the presence of an object within a video surveillance detection zone formed by the sensor; and
a controller, the controller in communication with the first detector and the sensor, the controller determining whether the object is present within the video surveillance detection zone when the activated tag is also in the interrogation zone.

14. The article detection system of claim 13, wherein the controller activates an alarm when the controller determines that the object is a relevant object and is present within the video surveillance detection zone when the activated tag is also in the interrogation zone.

15. The article detection system of claim 13, wherein the detector is an electronic article surveillance (EAS) tag detector.

16. The article detection system of claim 13, wherein the detector is a radio frequency identification (RFID) detector.

17. The article detection system of claim 16, wherein the controller identifies the object based on data obtained by the RFID detector.

18. The article detection system of claim 17, further including a database in communication with the controller, the database storing information corresponding to physical characteristics of objects, controller using the information to confirm identity of the object.

19. The article detection system of claim 13, wherein the controller determines a direction of motion of the object based on information received from the sensor, and wherein the controller activates an alarm when the controller determines that the object is moving in a predetermined direction and is present within the video surveillance detection zone when the activated tag is also in the interrogation zone.

20. The article detection system of claim 19, wherein the predetermined direction is toward a facility exit.
